(19) United States
(12) Patent Application Publication
(10) Pub. No.: US 2008/0097791 A1
(43) Pub. Date: Apr. 24, 2008

(54) System and Method for Coupling Patient Data with Executable Guideline Decision Support System

(75) Inventor: Yasser Alsafadi, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,669

(22) PCT Filed: Jul. 21, 2005
(86) PCT No.: PCT/IB05/52447

§ 371 Date: Jan. 25, 2007

(30) Foreign Application Priority Data
Jul. 26, 2004 (US) 60591076

(51) Int. Cl. G06Q 10/00; G06F 19/00; G06F 17/30

(52) U.S. Cl. 705/3; 707/100; 707/E17.009

(57) ABSTRACT

A system and method are provided for exchanging data between a local information storage system (26) storing first data elements associated with respective data, and an executable guideline decision support system (12) executable on at least one processor for storing a plurality of executable guidelines and executing the guidelines, including processing at least data associated with a second data element. The method includes the steps of generating a request to exchange data between the local information system and the decision support system (12); determining a first data element of the plurality of first data elements that corresponds to the second data element, and at least one interoperability parameter defining how the first and second data elements correspond; processing the data being exchanged in accordance with the determined at least one interoperability parameter; and transmitting the data being exchanged between the first and second data elements.

The present invention relates generally to decision support systems, and more particularly to a decision support system for use in assisting in providing healthcare to a patient using executable clinical guidelines.

Existing evidence demonstrates that improvement of the effectiveness of patient care can be achieved by using computer based implementation of evidence based clinical executable guidelines integrated with clinical workflow. The improvement may include the ability to provide patient specific recommendations at points of care. The executable guidelines make knowledge readily available to the clinician, without the clinician having to seek out this specific knowledge. Many professional societies (e.g., ACP-ASIM, ACR, ACC, etc.) prepare executable guidelines for the care of patients. Decision support systems (DSS) have been developed to integrate data related to the patient and his care which is stored in information systems with the execution of the executable guidelines.

However, decision support systems are not widely deployed at points of care, which is largely due to a mismatch between decision support systems and the information systems for storing patient data. One approach to overcome problems related to mismatches is to provide tight integration between the DSS and a local clinical information storage system, which makes it very difficult to share the DSS with other institutions.

Another approach was to design Medical Logic Modules (MLMs) associated with the DSS for providing compatibility between the DSS and the local information storage system for sharing of information therebetween. The MLM was provided with a special section in which terms used by the DSS were surrounded by additional terms for providing a mapping to terms used by the local information storage system. The additional terms are known as curly braces. The mapping between the MLM terms and the local information storage systems is institution specific and requires much custom tailoring. Hence the burden of preparing and using the mapping is commonly referred to as the “curly braces problem”. The cost and effort of building a DSS is very high, and its customization for use with a local information storage system is time consuming, interfering with the objective of sharing a DSS with many institutions.

The present invention is therefore directed to the problem of developing a system and method in which a DSS may be coupled to many information systems and deployed at many institutions.

It is an aspect of the present invention to provide a system and method for exchanging data. The system includes a local information storage system storing a plurality of first data elements associated with respective data relating to a plurality of patients, and an executable guideline decision support system executable on at least one processor. The decision support system includes an executable guideline storage system for storing a plurality of executable guidelines, and an execution engine for executing the guidelines, including processing at least data associated with a second data element.

The decision support system includes a search module executable on the at least one processor for generating a request to exchange data associated with the second data element between the local information system, the decision support system and a patient knowledge base. The patient knowledge base is executable on the at least one processor for determining a first data element of the plurality of first data elements that corresponds to the second data element, and at least one interoperability parameter defining how the first and second data elements correspond. The patient knowledge base is further executable for processing the data being exchanged in accordance with the determined at least one interoperability parameter for establishing semantic interoperability between the first and second data elements. A coupling is provided for transmitting the data being exchanged between the first and second data elements.

The method includes the steps of providing for generating a request to exchange data between the local information system and the decision support system, wherein the data being exchanged is included in the data associated with the second data element, and providing for determining a first data element of the plurality of first data elements that corresponds to the second data element and at least one interoperability parameter defining how the first and second data elements correspond. The method further includes the steps of; providing for processing the data being exchanged in accordance with the determined at least one interoperability parameter for establishing semantic interoperability between the first and second data elements; and providing for transmitting the data being exchanged between the first and second data elements.

These and other features, aspects, and advantages of the present invention will become better understood with reference to the below listed drawings, and detailed description of the invention:

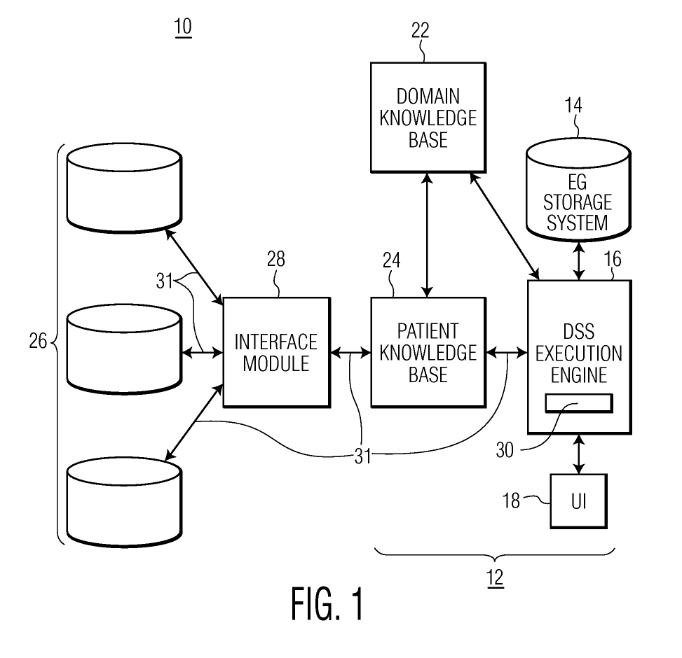

FIG. 1 shows a block diagram of an exemplary system including a decision support system coupled to a local information storage system in accordance with the present invention.

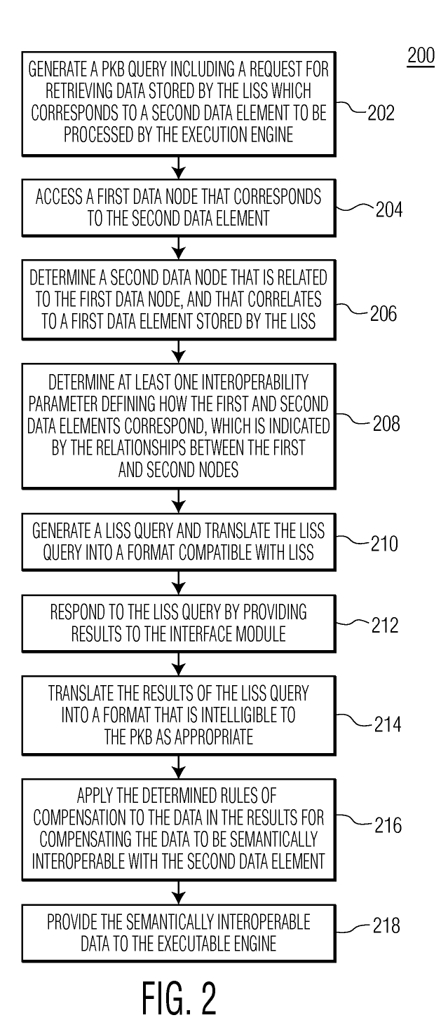

FIG. 2 shows a flowchart of steps performed during operation of the system shown in FIG. 1, where the decision support system requests data retrieval from the local information support system; and

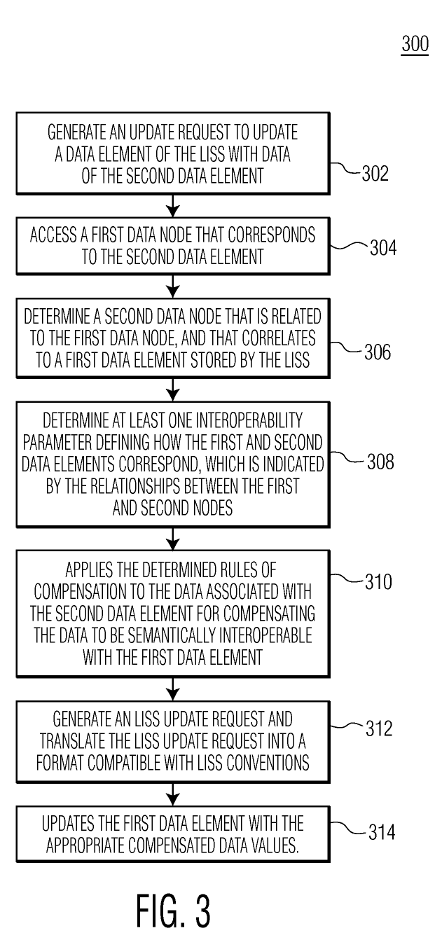

FIG. 3 shows a flowchart of steps performed during operation of the system shown in FIG. 1, where the decision support system updates data stored by the local information storage system.

The present invention describes a system having a decision support system for executing an executable clinical guideline for providing clinical guidance to a user in the treatment of a patient. The decision support system is coupled to a local information storage system storing data relating to a plurality of patients and/or their treatment. Data stored in the patient information storage system is needed by the decision support system for executing the guidance, and the decision support system may need to update data stored by the local information storage system. The decision support system includes a patient knowledge base which semantically matches information stored by the local information storage system with queries or updates generated by the decision support system for providing semantic interoperability between the decision support system and the local information storage system. The semantic interoperability ensures that the decision support system and the local information storage system have a common understanding of the meaning of requested or exchanged data and/or actions for preventing misinterpretations and ultimately faulty medical decisions.

FIG. 1 shows a preferred embodiment of an exemplary system 10 having a decision support system coupled to a local information storage system for use in assisting in providing decision support in the healthcare of a patient. The system 10 includes an executable guideline decision support system (DSS) 12, which includes an executable guideline storage system 14, a DSS execution engine 16, a user interface (UI) 18, a domain knowledge base (DKB) 22, a patient knowledge base (PKB) 24, and a request module 30. The system 10 further includes an interface module 28 and a local information storage system (LISS) 26 storing data related to at least one patient and/or treatment of the at least one patient. The execution engine 16 includes a request module 30 for generating queries or requests for searching through the PKB 24 for finding semantically correct data needed for the execution of a guideline, or for determining a semantically correct way to use data processed by the execution engine 16, such as for updating the LISS 26.

The term storage system refers to a system for storing and accessing information, such as one or more databases or repositories, where the storage system may be structured and/or not structured. The DSS 12 is implemented using at least one processor and at least one storage medium accessible by the at least one processor. The components of the system 10 (e.g. the local information storage system 26; the interface module 28; and the DSS 12 and its components (e.g., the evidence guideline storage system 14, the DSS execution engine 16, the user interface 18, the domain knowledge base 22, the patient knowledge base 24 and the request module 30)) are coupled via wired or wireless couplings 31 which may be provided by one or more networks, such as a LAN, a WAN, an intranet, the Internet or a combination thereof.

The respective components of the system 10 may share resources of the at least one processor and the at least one storage medium, or may have exclusive use of one or more of the resources. The at least one processor may include, for example, a personal computer, a microprocessor, a handheld computing device, a server, etc. The at least one storage medium may include, for example, a hard drive, a CD-ROM, RAM, flash memory, volatile memory, non-volatile memory, etc.

The LISS 26 is preferably selectable from a plurality of LISSs of different types, where the DSS is capable of exchanging information with the various LISSs of the different types of LISSs. The LISS 26 stores data related to a plurality of patients and their treatment, which may include patient information, lab results, imaging results, etc., which are preferably stored as a plurality of first data elements that are configured in accordance with at least one of the types of standard electronic medical records.

The DSS 12, or a portion thereof, may reside on a server or on storage accessible thereby, where the server is accessible by a plurality of computers. For example, a user may operate a workstation, such as a personal computer, in order to use the DSS 12, where execution of the DSS 12 is performed at the server or at the workstation. Alternatively, the DSS may reside on one or more workstations or on storage accessible thereby. Furthermore, the DSS 12 may be embedded within or linked to another system, such as an administrative information storage system (e.g., for a hospital, nursing home, laboratory, etc.). Exemplary applications for the DSS 12 include assistance in resource management, planning and/or quality assurance.

The guideline storage system 14 stores a plurality of executable guidelines. The guidelines stored in the executable guideline storage system 14 are preferably evidence-based, and developed in accordance with experience and research of experts in the field. The guidelines are encoded by appropriate encodings, such as ASBRU, GLIF, EON, GUIDE, PRODIGY and PROforma, etc. The guideline storage system 14 is preferably searchable for finding a particular guideline or the guideline that best meets criteria, typically the guideline that provides clinical guidance for treatment within a context best matching a combination of at least one of patient context, user context, care context, etc.

The DSS 12 accesses a selected guideline from the guideline information system 14. The guideline may be selected by the user by instructing the DSS 12 to access the selected guideline, and/or the guideline may be selected by the DSS 12 in accordance with clinical context related data available to the DSS 12, such as the context of the patient's present state, medical history, care provided so far, etc. A clinical application may be used to submit clinical context data to the DSS 12, or the user interface 18 may be used to allow the user to enter clinical context data. A copy of the selected guideline or links thereto may be stored temporarily or permanently, such as at the user's work station, with the patient's data in the local information storage system 26, and/or in a workspace provided by and/or accessible by the executable guideline system 14 or the DSS 12. The stored copy may be customized for the individual, such as by eliminating or bypassing certain steps of the guideline, e.g., by using a guideline editing tool.

The respective guidelines include at least one series of steps, each series including at least one step. The individual steps of the guideline include a variety of types of steps. One type of step is an action step instructing a user (e.g., clinician, nurse, hospital administrator, technician, etc.) or a component of the system 10 to perform an action. Examples of actions include gathering information, performing tests, providing treatment, and jumping to another step of the guideline or of a different guideline. Another type of step is a choice step for prompting a user to make a decision, such as deciding the next step to be performed from a choice of at least two steps. Another type of step is a state step representing the current state of the patient, an entity related to the patient or the patient's treatment, or the execution process. Still another type of step is a case step, where at least one algorithm is performed for making a determination, such as for deciding which step to perform next. Information gathering, such as from the LISS 26, may be performed during execution of the various types of steps.

Interaction between the DSS 12 and the user is provided via the guideline user interface 18. The guideline being executed is presented to the user via the guideline user interface 18. The guideline user interface 18 may generate a display, such as for display on a screen of a handheld or desktop computing device, and process input from an input device, such as a pointing device and/or a keyboard, etc. The guideline user interface 18 may generate a graphical user interface (GUI), but is not limited thereto. For example, the guideline user interface 18 may provide an interface including a voice activated system that provides menu choices and/or prompts via audio messages, such as for use via a telephone. User responses may be provided by key pushes and/or voice responses, and voice recognition technology may be used to process the responses.

The execution engine 16 of the DSS 12 executes at least one executable guideline stored in the guideline storage system 14. Execution of the at least one executable guideline typically includes accessing and processing data stored in the domain knowledge base 22 and/or the local information storage system 26. However, different uses or interpretations of data and terminology used by the DSS 12 and the LISS 26 will lead to misinterpretations of data and subsequent wrong medical decisions. The patient knowledge base provides semantic interoperability for ensuring that the requesters (e.g., the execution engine 16) and providers of information (e.g., the LISS 26) have a common understanding of the meaning of the requested data and services. Semantic interoperability implies a semantic matching process which is highly context dependent, and may include compensation as necessary to ensure compatibility between the requesters and providers of information. Semantic matching applies to the definition of a concept as well as its instantiation.

Examples of semantic differences include differences in numeric representation, units, techniques and conditions of measurement, precision of measurement, degrees of error, sources of information (e.g., expert physician versus computer algorithm), degree of confidence for a value or diagnosis, demographic conditions (e.g., gender, weight, height, skin color, ethnicity), clinical conditions, ambient conditions, point of reference, use and scope of terminology, etc.

The PKB 24 and the DKB 22 are both populated information storage systems, preferably configured as ontologies. In the respective ontologies, knowledge about the domain of patient data is represented in a declarative language. The set of objects that can be represented by the declarative language is called the universe of discourse. The ontology defines a set of representational terms and provides formal axioms that constrain the interpretation and well-formed use of these terms, as described below. The interface module 28, which interfaces between the PKB 24 and the LISS 26, may be implemented using specifications that are available, such as HL7 Templates or Australian Archtypes specifications.

The PKB 24 stores data nodes holding patient related data; relationships between the data nodes; and attributes associated with respective data nodes. The data may be configured in accordance with standard medical data models (e.g., HL7, DICOM, etc.). The relationships, such as semantic links, show how the data nodes are related, such as via causal, temporal and/or group membership relationships. The attributes include information that describes the context and semantic meaning of the data for constraining the interpretation and use of the data, such as how the data was obtained, how the data is represented, etc. For example, the attributes may describe characteristics about the data, such as usage of numeric representation, units, techniques and conditions of measurement, precision of measurement, degrees of error, sources of information (e.g., expert physician versus computer algorithm), degree of confidence for a value or diagnosis, demographic conditions, related clinical conditions, ambient conditions, point of reference, terminology and scope thereof, etc. Furthermore, the attributes may include an LISS indicator for indicating when a data node corresponds to a data element of a local information storage system and/or which local information storage system.

The DKB 22 stores information that is not related to specific patients, such as data that is related to particular diseases, drugs, treatments, etc. The information may include algorithms and/or equations which are useful for establishing semantic interoperability, such as for defining relationships and/or compensating between incompatible uses of information, e.g., compensating for differences in units, points of reference, ambient conditions, etc. The DKB 22 provides semantic links between stored information. For example, the DKB 22 may include a domain for obstetrics including the elements abdominal circumference (AC) of a fetus and estimated fetal weight (EFW). A semantic link may be provided between the AC and EFW elements for establishing that AC may be used for deriving EFW. In another example, the elements femur length (FL) and menstrual age (MA), may be included within the same domain or another domain, such as orthopedics. Another semantic link may be provided between the FL and MA elements establishing that FL is a function of MA.

With reference to FIG. 2, a flowchart 200 is provided showing steps performed during operation of the system 10, where the DSS 12 requests data from the LISS 26. At step 202, the request module 30 generates a PKB query including a request for retrieving data stored by the LISS 26 which corresponds to a particular second data element being processed by the execution engine 16 while maintaining semantic interoperability with the particular second data element. The desired data which to be retrieved in accordance with the request is data that is to be exchanged between the LISS 26 and the DSS 12. The PKB query is more specifically requesting that the PKB 24 find information about how to find the desired data in one of the first data elements stored in the LISS 26, and determine how the data found can be used while maintaining semantic interoperability with the execution engine 16. Preferably, the attributes of the second data element, which maintain semantic interoperability with the second data element being processed by the execution engine 16, are known by the PKB 24. Otherwise, the PKB query could provide the attributes by consulting the DKB 22, since the attributes have already been specified when defining the data elements of the guideline. The PKB query may request retrieval of data that corresponds to more than one first data element and/or more than one second data element, however for the purpose of clarity, the following explanation relates to the case of retrieving data corresponding to one first data element and one second data element.

The PKB 24 processes the PKB query. At step 204, the PKB 24 accesses a first data node that corresponds to the second data element. At step 206, the PKB 24 determines a second data node that is related to the first data node, and that correlates to a first data element stored by the LISS 26. The second data node is located by processing the at least one relationship associated with the first data node and checking for correlation to a first data element stored by the LISS 26. Correlation to the first data element stored by the LISS 26 may be determined by checking the LISS indicator, if included with the data nodes of the PKB 24. Otherwise, a list provided of the plurality of first data elements or the LISS 26 itself may be consulted. For instances in which several possible data nodes relate to the first data node and correlate to a first data element stored by the LISS 26, the best data node is selected to be second data node in accordance with predetermined conditions, such as in accordance with user selection, simplest relationship, having attributes most common to the first node, etc.

At step 208, the PKB 24 determines at least one interoperability parameter defining how the first and second data elements correspond, which is indicated by the relationships between the first and second nodes. The interoperability parameter includes at least one of at least one relationship defining how the first and second data elements are related; and at least one set of at least one rule of compensation for defining how to compensate between the first and second data elements.

The at least one relationship is determined in accordance with the relationships configured between the first and second nodes, and may include the identifier used by the LISS 26 to identify the data element of interest. The rule(s) of compensation are determined by comparing the attributes of the first data node (which corresponds to the second data element) and the second data node (which corresponds to the first data element). The rules of compensation are determined by determining differences in the attributes of the first node relative to the attributes of the second node, and creating rules to compensate for the determined difference for providing semantic interoperability between the first and second data elements, and/or to provide the ability to derive information from data available in the LISS 26. Preferably, the PKB queries are configured as descriptive logic based queries. It is preferable that the request module 30 include at least one artificial intelligence module for formulating the PKB queries. The PKB 24 may consult the DKB 22 or intelligent agent(s) for determining the second data node and the interoperability attributes.

The interoperability parameters may be stored temporarily or permanently in association with at least the second data element or the first node for subsequent use thereof. Storage of the determined relationships and the determined rules of compensation, or access thereto, may be provided by the PKB 24 and the DKB 22, in accordance with design choice. If the interoperability parameters have been stored and are available, instead of determining them, they are retrieved from storage.

At step 210, the PKB generates a LISS query in accordance with the determined at least one relationship interoperability parameter for querying the LISS 26 to retrieve data associated with the first data element. The at least one relationship interoperability parameter is used for locating the first data element within the LISS. The interface module 28 translates the LISS query into a format that is understood by the LISS 26. At step 212, the LISS 26 responds to the LISS query by providing results to the interface module 28, where the results include data associated with the first data element. At step 214, the interface module 28 further translates the results of the LISS query into a format that is intelligible to the PKB 24 as appropriate. The interface module 28 provides the translated results to the PKB 24.

At step 216, upon receiving the results, the PKB 24 applies the determined rules of compensation to the results data for compensating the data in order for the results data to be semantically interoperable with the second data element, for ensuring accurate processing by the execution engine 16 of the DSS 12. At step 218, the PKB 24 provides the semantically interoperable data to the executable engine 16, which the executable engine 16 may use for processing and/or for updating the evidence guideline storage system 14.

With reference to FIG. 3, a flowchart 300 is provided showing steps performed during operation of the system 10, where the DSS 12 updates data stored in the LISS 26. At step 302, the PKB 24 receives an update request from the execution engine 16 to update a data element of the LISS 26 with data of a second data element, which is the data being exchanged. The update request may request an update that corresponds to more than one first data element and/or more than one second data element, however for the purpose of clarity, the following explanation relates to the case of retrieving data corresponding to one first data element and one second data element.

At step 304, the PKB 24 accesses a first data node that corresponds to the second data element. At step 306, the PKB 24 determines a second data node that is related to the first data node, and that correlates to a first data element stored by the LISS 26. At step 308, the PKB 24 determines at least one interoperability parameter defining how the first and second data elements correspond, which is indicated by the relationships between the first and second nodes. If the interoperability parameters have been stored and are available, instead of determining them, they are retrieved from storage.

At step 310, the PKB 24 applies the determined rules of compensation to the data associated with the second data element for compensating the data in order for the data to be semantically interoperable with the first data element. At step 312, the PKB generates a LISS update request in accordance with the determined at least one relationship interoperability parameter for instructing the LISS 26 to update the first data element with the compensated data. The at least one relationship interoperability parameter is used for locating the first data element and their corresponding elements in the LISS 26. The interface module 28 translates the LISS update request into a format that is understood by the LISS 26 in accordance with conventions used by the LISS 26 for properly updating the first data element. At step 314, the LISS 26 updates the first data element with the appropriate compensated data.

When developing the DSS 12, it is preferable to prepare the DSS 12 by using semantics conventions used by most available LISSs 26. When developing the PKB 24, it does not need to exhaustively replicate the LISS 26 which it is to be used with. Preferably, the PKB 24 is populated with knowledge in accordance with anticipated incompatibilities between the DSS 12 and a wide variety of LISSs 26. The universe of discourse of the PKB 24 needs to be large enough or expanded to accommodate the data it processes, e.g., data originating from the DSS 12 and data stored in the LISS 26 which correspond to the data originating in the DSS 12.

It is contemplated that the PKB may be developed as it is being used. For example, upon detection of an interoperability problem that has not been successfully rectified, user intervention may be requested. If the user input is determined successful, the execution module 16, PKB 24 and/or interface module 28 of the system 10, as appropriate, may be updated with the suggested solution (permanently or temporarily) for future use. Alternatively, upon detection of a similar problem, an intelligent agent may be queried to provide a solution. The intelligent agent's recommended solution, if determined successful, may be used to update the system 10 as appropriate.

It is further contemplated that an update to a system 10, such as described above, may be uploaded to a server which is connected to a plurality of systems 10. The update may be downloaded to systems 10 of the plurality of systems 10 that might be prone to encountering a similar interoperability problem. The uploading and downloading of updates may be automatic or supervised by system administrators of the respective systems.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

1. A system for exchanging data comprising:
a local information storage system (26) storing a plurality of first data elements associated with respective data relating to a plurality of patients;
an executable guideline decision support system (12) executable on at least one processor having an executable guideline storage system (14) for storing a plurality of executable guidelines and an execution engine (16) for executing the guidelines including processing at least data associated with a second data element, the decision support system (12) comprising:
a search module (30) executable on the at least one processor for generating a request to exchange data associated with the second data element between the local information system (26) and the decision support system (12); and
a patient knowledge base (24) executable on the at least one processor for determining a first data element of the plurality of first data elements that corresponds to the second data element, and at least one interoperability parameter defining how the first and second data elements correspond; and for processing the data being exchanged in accordance with the determined at least one interoperability parameter for establishing semantic interoperability between the first and second data elements; and
a coupling (31) for transmitting the data being exchanged between the first and second data elements.

2. The system in accordance with claim 1, wherein the at least one interoperability parameter includes at least one of at least one relationship for defining how the first and second data elements are related and at least one set of at least one rule of compensation for defining how to compensate between the first data element and the corresponding second data element.

3. The system in accordance with claim 2, wherein:
the patient knowledge base (24) is executable on the at least one processor for at least one of storing and accessing a plurality of data nodes, at least one relationship associated with respective data nodes of the plurality of data nodes defining how the respective data nodes are related to other data nodes of the plurality of data nodes, and at least one attribute associated with the respective nodes;
accessing a first data node of the plurality of data nodes that corresponds to the second data element;
determining a second data node capable of correlating to a data element of the first plurality of data elements by processing at least the at least one relationship associated with the first data node for determining the first data element;
determining the at least one relationship of the at least one interoperability parameter in accordance with the at least one of stored and accessed at least one relationship defining the relation between the first and second nodes; and
determining the at least one rule of compensation of the at least one interoperability parameter in accordance with the at least one of stored and accessed at least one attribute associated with the first and second data nodes.

4. The system according to claim 1, wherein the patient knowledge base (24) is configured as an ontology.

5. The system according to claim 1, wherein the search module (30) is configured with artificial intelligence for generating the request.

6. The system according to claim 1, wherein the request is configured as a descriptive logic based query.

7. The system according to claim 1, wherein the system further comprises an interface module (28) for interfacing between the patient knowledge base (24) and the local information storage system (26).

8. The system according to claim 1, wherein the system further comprises a domain knowledge base (22) executable on the at least one processor for storing information unrelated to the plurality of patients, and related to the at least one interoperability parameter associated with respective data nodes of the plurality of data nodes; and
wherein the patient knowledge base (24) accesses the domain knowledge base (22) for determining the least one interoperability parameter.

9. The system according to claim 3, wherein:
the request is for retrieving data from the local information storage system (26) to be used in the processing of the second data element; and
the patient knowledge base (24) is further executable on the at least one processor for generating a query to the local information storage system (26) requesting retrieval of the data being exchanged from the data associated with the first data element, wherein the query is generated in accordance with the at least one relationship of the at least one interoperability parameter; for receiving the requested data being exchanged; for processing the received data being exchanged in accordance with the at least one rule of compensation; and for updating the data associated with the second data element with the compensated data for processing of the updated data by the execution engine (16).

10. The system according to claim 1, wherein:
the request is for updating data stored by the local information storage system (26) with the data being exchanged; and
the patient knowledge base (24) is further executable on the at least one processor for processing the data being exchanged in accordance with the at least one rule of compensation for compensating the data being exchanged; for generating an update request in accordance with the at least one relationship of the at least one interoperability parameter for updating the first data element with the compensated data being exchanged; and for transmitting the update request to the local information storage system (26).

11. The system according to claim 1, wherein the local information storage system (26) is selectable from a plurality of local information storage system (26) having different types of operability conventions, and the decision support system (12) is capable of establishing semantic interoperability for exchanging data with the plurality of local information storage systems (26).

12. A method for exchanging data between an executable guideline decision support system and a local information storage system (26) comprising the steps of:
providing a local information storage system (26) storing a plurality of first data elements associated with respective data;
providing an executable guideline decision support system (12) including:
providing an executable guideline storage system (14) for storing a plurality of executable guidelines; and
providing an execution engine (16) for executing at least one guideline of the plurality of guidelines including processing at least data associated with a second data element;
providing for generating a request to exchange data between the local information system and the decision support system (12), wherein the data being exchanged is included in the data associated with the second data element;
providing for determining a first data element of the plurality of first data elements that corresponds to the second data element, and at least one interoperability parameter defining how the first and second data elements correspond;
providing for processing the data being exchanged in accordance with the determined at least one interoperability parameter for establishing semantic interoperability between the first and second data elements; and
providing for transmitting the data being exchanged between the first and second data elements.

13. The method in accordance with claim 12, wherein the at least one interoperability parameter includes at least one of at least one relationship for defining how the first and second data elements are related and at least one set of at least one rule of compensation for defining how to compensate between the first data element and the corresponding second data element.

14. The method in accordance with claim 13, wherein the providing for determining a first data element further comprise the steps of:
providing for at least one of storing and accessing a plurality of data nodes, at least one relationship associated with respective data nodes of the plurality of data nodes defining how the respective data nodes are related to other data nodes of the plurality of data nodes, and at least one attribute associated with the respective nodes;
providing for accessing a first data node of the plurality of data nodes that corresponds to the second data element;
providing for determining a second data node capable of correlating to a data element of the first plurality of data elements by processing at least the at least one relationship associated with the first data node for determining the first data element;
providing for determining the at least one relationship of the at least one interoperability parameter in accordance with the at least one of stored and accessed at least one relationship defining the relation between the first and second nodes; and
providing for determining the at least one set of at least one rule of compensation of the at least one interoperability parameter in accordance with the at least one of stored and accessed at least one attribute associated with the first and second data nodes.

15. The method in accordance with claim 14, wherein:
the request step is for retrieving data from the local information storage system (26) to be used in the processing of the second data element; and
the providing for processing the data step comprises the steps of:
providing for generating a query to the local information storage system (26) for retrieving the data being exchanged from the data associated with the first data element, wherein
the query is generated in accordance with the at least one relationship of the at least one interoperability parameter;
providing for processing the data being exchanged received in response to the query in accordance with the at least one rule of compensation for compensating the data being exchanged; and updating the data associated with the second data element with the compensated data for processing of the updated data by the execution engine (16).

16. The method in accordance with claim 14, wherein:
the request step is for updating data stored by the local information storage system (26) with the data being exchanged; and
the providing for processing the data step comprises the steps of:
providing for processing the data being exchanged in accordance with the at least one rule of compensation for compensating the data being exchanged;
providing for generating an update request in accordance with the at least one relationship of the at least one interoperability parameter for updating the first data element with the compensated data being exchanged; and
providing for transmitting the update request to the local information storage system.
